(19) United States
(12) Patent Application Publication
(10) Pub. No.: US 2014/0371886 A1
(43) Pub. Date: Dec. 18, 2014

(54) METHOD AND SYSTEM FOR MANAGING PERFORMANCE OF AN ATHLETE

(71) Applicant: Lakshya Jain, Los Altos, CA (US)

(72) Inventor: Lakshya Jain, Los Altos, CA (US)

(21) Appl. No.: 14/328,729

(22) Filed: Jul. 11, 2014

(51) Int. Cl. G06K 9/00; A63B 71/06

(52) U.S. Cl. CPC G06K 9/00342; A63B 71/06
USPC 700/91

(57) ABSTRACT

The present disclosure provides a method and system for controlling performance of an athlete. The method and system includes an input/output module, an analysis module and a report generation module. The input/output module receives a plurality of a pre-defined set of one or more biomarkers associated with each of one or more users, and fetches a plurality of the pre-defined set of one or more user inputs. The analysis module analyzes the received plurality of the pre-defined set of the one or more biomarkers and the fetched plurality of the pre-defined set of the one or more user inputs. The report generation module generates a profile for each of the one or more users based on analysis of the pre-defined set of the one or more biomarkers and the pre-defined set of the one or more user inputs.

### TECHNICAL FIELD

The present invention relates to the field of athletics and biomedical technology and, in particular, relates to utilization of the biomedical technology for improving performance of an athlete.

### BACKGROUND

Optimizing performance of athletes in various athletic activities has always been an important issue. Examples of the athletic activities include but may not be limited to basketball, volleyball, cricket, hockey, soccer and tennis. Most of the athletic activities require physical and mental strength, stamina, energy and the like. In addition, the athletic activities introduce changes in physical and mental aspects of body of athletes. It is well known that in the athletic activities, athletes undergo changes in respiration, blood pressure, heart rate, hydration level, oxygen saturation, etc. Generally, the athlete is required to undergo physical and/or medical health check-ups before, during and/or after an athletic event. Many times, athletes have to visit a physician for the physical and/or medical health check-ups. The physician examines the athletes for physical fitness. The physician uses different kind of machines and/or equipment to examine the parameters for the physical and/or medical check-ups of the athletes. For example, the physician performs X-Ray to detect any bone/muscle damage using an X-Ray machine, measures blood pressure using a sphygmomanometer, measures cardiovascular system problems using an electrocardiogram, oxygen saturation using pulse oxymeter, and the like. Moreover, the physician may prescribe exercises and other measures to counter-balance any abnormalities detected.

Presently, in athletics, use of biomedical technology is limited to drug intake, exercise equipment and medicated bands/belts. Moreover, the athletes are required to visit the physician for selection of appropriate biomedical technology to handle various health issues. However, to win in the athletic events, the performance of athletes must be monitored at a mental and physical level on a regular basis. Furthermore, it is important to monitor that training of the athletes is appropriate because both over-training and under-training can be harmful. For example, over-training may cause health issues or abnormalities in parameters of health including injuries to muscles, suboptimal development of strength and endurance and the like.

Most of the times, performance of the athletes is affected due to physical and mental health issues. However, the athletes do not realize the effect in their performances. Moreover, the athletes are required to be physically and mentally fit for the athletic events. Thus, monitoring and analysis of the physical and mental health issues of the athletes is important for improving overall performance of the athletes.

In addition, performance of the athletes depends upon minute details and trends. For example, performance of the athlete may get deteriorated due to stress increment, high blood pressure, heart problems and the like. However, by analyzing and determining changes in performance at regular time intervals, the athlete or any other person (for example, coach, mentor and the like) in association of the athlete may take certain measures to counter-balance the various parameters of athlete's health to improve performance of the athlete. However, no method and system is present that enables the athletes to analyze their performance at various instances of the athletic event. Moreover, no method and system is present that enables the athletes to monitor physical and mental health issues associated with them. Further, no method and system is present that enables the athletes to improve their performance in real time. Furthermore, no method and system is present that enables the athletes to determine cause of change in their performance. Furthermore, no method and system is present that analyzes correlation between various exercise routines and health issues of the athletes. Furthermore, no method and system is present that notifies the athletes in real time when their performance is not optimal.

In light of the above stated discussion, there is a need for a method and system to determine the physical and mental health issues of the athletes. In addition, the method and system should provide analysis data/report, regarding performance and the physical and mental health issues, to the athletes at regular time intervals. Moreover, the method and system should enable any person in association of the athletes to monitor the performance of the athletes in real time and provide assistance to the athletes for improving the performance of the athletes.

### SUMMARY

In an aspect of the present disclosure, a method and system for monitoring and controlling performance of an athlete is provided. The method and system include receiving a plurality of a pre-defined set of one or more biomarkers which can be associated with the physical or mental status associated with each of one or more users dynamically through an associated communication device, fetching a plurality of a pre-defined set of one or more user inputs dynamically through the associated communication device, analyzing both the received plurality of the pre-defined set of one or more biomarkers associated with each of the users and the fetched plurality of the pre-defined set of one or more user inputs from each user with respect to a plurality of pre-defined set of one or more physiological, psychological or environmental parameters, and generating a profile for each of the one or more users based on an analysis of the received and fetched plurality of the biomarkers and user inputs with respect to the plurality of pre-defined set of one or more environmental parameters.

It may be noted that the mental status of the user can be monitored using quantifiable data, gathered from the available biosensors or collected via a series of user inputs. The quantifiable data may include ratings of mental status of the user, information about mental routines of the user, activities performed by the user before the athletic event and the like events where performance can be quantifiably evaluated. It is to be noted that the methods stated above are merely examples and that the mental state of the user can be judged in many other related ways. Following the collection of the data, the data is related to the performance of the user in the event to provide information about relation of the user's mental and physical states with the performance of the user, and thus the data can be modulated for optimal performance. The physical and/or mental state may have been produced by a set of conditioning that the user undergoes prior to the event under consideration. Additionally, the application monitors the conditioning regimen of the user (athlete) and compares the conditioning regimen undertaken with the performance of the user in real-time and at the event. The application analyzes trends in the performance of the user related to specific aspects of training and therefore judges the impact that such training types may have upon the user (athlete). For example, the application may monitor an Olympic sprinter's workout and determine that when the sprinter focuses on core-body workouts before a race, he tends to perform better in comparison to when he focuses on some different aspect of his conditioning. The application may then recommend a greater focus upon core workouts. The example and the methods provided above are just some manners; however, there can be various methods and scenarios in which the idea may be implemented.

In an embodiment of the present disclosure, the method and system include determining an optimal performance of each of the one or more users based on a generated profile.

In another embodiment of the present disclosure, the method and system include sharing one or more pre-formatted messages with one or more stakeholders based on comparison of generated profile and real time performance of each of the one or more users during an event.

In yet another embodiment of the present disclosure, the method and system include enabling transmission of one more recommendation messages by one or more stake holders based on determined optimal performance and comparison of generated profile and real time performance of each of the one or more users during an event.

In yet another embodiment of the present disclosure, the plurality of the pre-defined set of the one or more biomarkers associated with each of the one or more users are dynamically received through the associated communication device of each of the one or more users at pre-defined time interval.

In yet another embodiment of the present disclosure, the plurality of the pre-defined set of one or more user inputs from each of the one or more users are dynamically fetched through the associated communication device of each of the one or more users at pre-defined time interval.

In yet another embodiment of the present disclosure, the method and system include providing recommendations to each of the one or more users pertaining to the pre-defined set of the one or more biomarkers:

In yet another embodiment of the present disclosure, the method and system include providing recommendations to each of the users for delivering an optimal performance during an event.

In another aspect of the present disclosure, the system includes an input/output module, an analysis module and a report generation module. The input/output module is configured to receive the plurality of the pre-defined set of the one or more biomarkers associated with each of one or more users dynamically through the associated communication device of each of the one or more users and fetch the plurality of the pre-defined set of the one or more user inputs from each of the one or more users dynamically through the associated communication device of each of the one or more users. The analysis module is configured to analyze both the received plurality of the pre-defined set of the biomarkers associated with each of the users and the fetched plurality of the pre-defined set of user inputs from each of the users with respect to the plurality of the pre-defined set of the one or more physiological, psychological or environmental parameters. The report generation module is configured to generate the profile for each of the one or more users based on an analysis of both the received plurality of the pre-defined set of the one or more biomarkers and the fetched plurality of the pre-defined set of the user inputs with respect to the plurality of the pre-defined set of the one or more physiological, psychological or environmental parameters.

In an embodiment of the present of the present disclosure, the system includes a determination module to determine optimal performance of each of the one or more users based on generated profile.

In another embodiment of the present disclosure, the system includes a sharing module to share one or more pre-formatted messages with one or more stakeholders based on comparison of the generated profile and real time performance of each of the one or more users during the event.

In yet another aspect of the present disclosure, a computer system includes one or more processors and a non-transitory memory including instructions that, when executed by the one or more processors, causes the one or more processors to perform a set of steps.

### BRIEF DESCRIPTION OF THE FIGURES

Having thus described the invention in general terms, reference will now be made to the accompanying drawings, which are not necessarily drawn to scale, and wherein:

FIG. 1 illustrates a system showing various components for controlling performance of users, in accordance with various embodiments of the present disclosure;

FIG. 2 illustrates a system showing interaction between communication devices and an application server, in accordance with various embodiments of the present disclosure; and

FIG. 3 is a flowchart illustrating a method for controlling the performance of an athlete, in accordance with the various embodiments of the present disclosure; and

FIG. 4 illustrates a block diagram of a dedicated computer that acts as the server, in accordance with various embodiments of the present disclosure.

### DETAILED DESCRIPTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

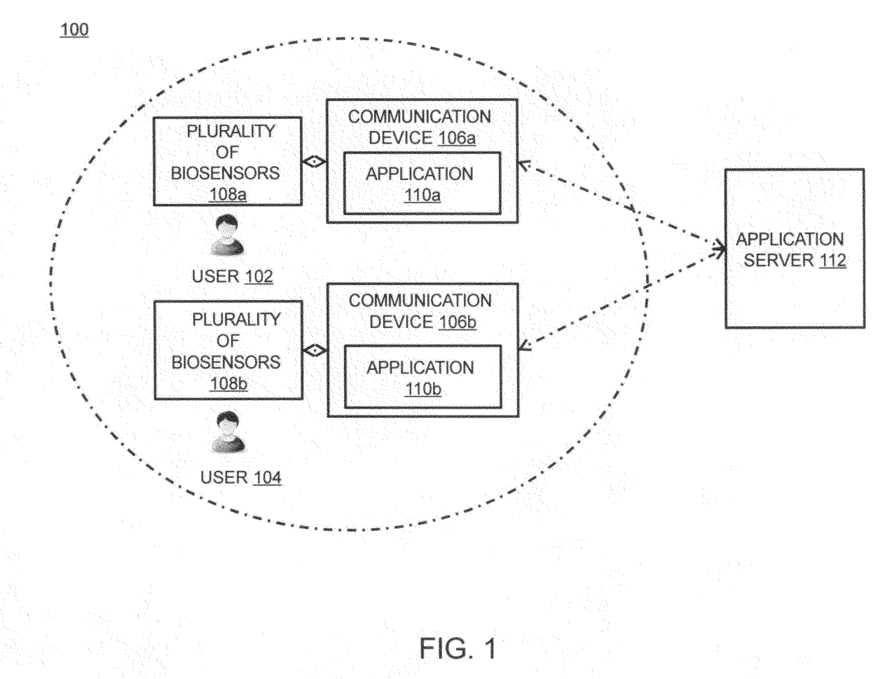

FIG. 1 illustrates a system 100 showing various components for controlling performance of users, in accordance with various embodiments of the present disclosure. The system 100 includes a user 102, a user 104, a communication device 106a, a communication device 106b, a plurality of biosensors 108a, and a plurality of biosensors 108b, an application 110a, an application 110b and an application server 112. Examples of the user 102 and the user 104 include but may not be limited to athlete, coach and the like. The user 102 is associated with the plurality of biosensors 108a and the user 104 is associated with the plurality of biosensors 108b. In addition, the plurality of biosensors 108a are connected with the communication device 106a and the plurality of biosensors 108b are connected with the communication device 106b. Examples of the communication device 106a and the communication device 106b include but may not be limited to mobile phones, tablets, desktop computers and the like. Various mediums can be used for connectivity including interne, intranet, Bluetooth, Wi-Fi and the like. In addition, the communication device 106a is associated with the application 110a and the communication device 106b is associated with the application 110b. Moreover, the communication device 106a and the communication device 106b are connected with the application server 112.

In an embodiment of the present disclosure, the plurality of biosensors 108a-b can be used in wearable components including wristbands, belts, shoes and the like. The plurality of biosensors 108a-b is associated with the users 102-104 at the time of training as well as live athletic event/match. The plurality of biosensors 108a-b gather data (biomarkers) of the users 102-104 related to heart rate, body temperature, respiration rate, blood flow, oxygen saturation, stress level and the like using Photoplethysmography (PPG) and the like. In addition, the plurality of biosensors 108a-b collect data related to environmental aspects including temperature, weather, humidity, UV exposure and the like. It may be noted that number of the plurality of biosensors 108a-b associated with the user 102-104 vary at different points of time. For example, the user 102-104 may wear more biosensors during training as compared to live-event/match. Moreover, the users 102-104 enter data related to physiological aspects, psychological aspects and the like. For example, the users 102-104 may enter the data including number of sleep hours, diet undertaken, type of exercises performed and the like utilizing pre-defined forms provided by the applications 110a-b. Further, each of the applications 110a-b, running in the communication devices 106a-b, collects data from the plurality of biosensors 108a and the users 102-104.

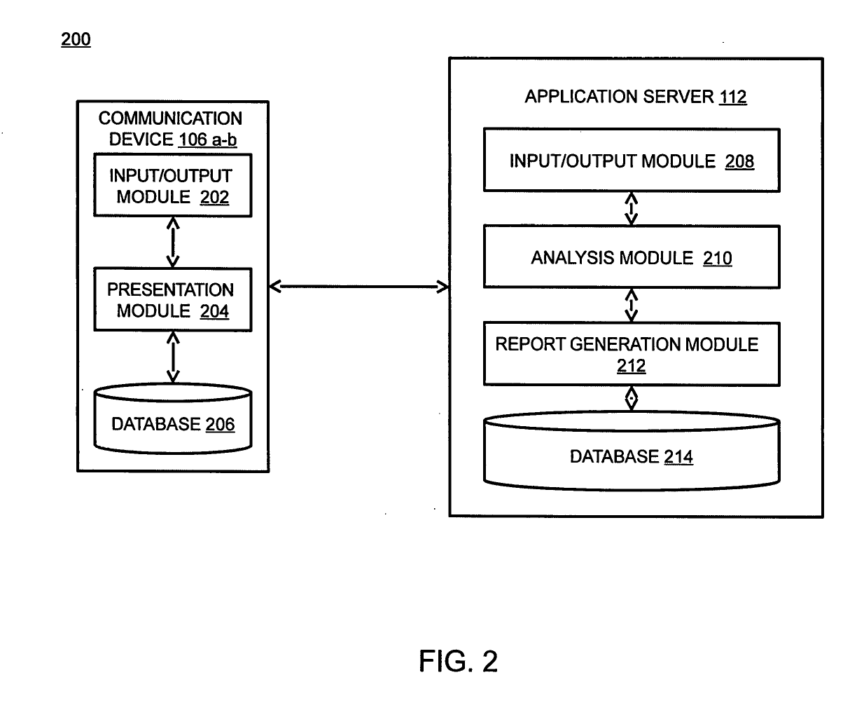

FIG. 2 illustrates a system 200 showing interaction between the communication devices 106a-b and the application server 112, in accordance with various embodiments of the present disclosure. The communication device 106a-b includes an input/output module 202, a presentation module 204 and a database 206. Moreover, the application server 112 includes an input/output module 208, an analysis module 210, a report generation module 212 and a database 214. The input/output module 202 of the communication devices 106a-b receives an input from the user 102-104. The presentation module 204 of the communication devices 106a-b handles graphics data. The database 206 of the communication devices 106a-b stores data entered by the user 102-104 and data captured by the plurality of biosensors 108a-b. The data entered by the user 102-104 includes number of sleep hours, diet undertaken and the like. In addition, the data measured by the plurality of biosensors 108a-b includes heart rate, body temperature, respiration rate, blood flow, oxygen saturation, muscle activation, posture, stress, blood pressure, galvanic skin response, gait and the like. Moreover, the plurality of biosensors 108a-b capture data related to the environmental aspects including temperature, weather, humidity and the like.

As shown, the communication devices 106a-b is connected with the application server 112. The input/output module 208 receives a plurality of a pre-defined set of the one or more biomarkers associated with each of the one or more users 102-104 dynamically through the associated communication device (the communication devices 106a-b) of each of the one or more users 102-104 and fetches a plurality of a pre-defined set of one or more user-inputs from each of the one or more users 102-104 dynamically through the associated communication device of each of the one or more users 102-104. Further, the input/output module 208 receives the data from the input/output module 202 of the communication devices 106a-b. The data collected by the input/output module 208 of the application server 112 includes but may not be limited to data entered by the users 102-104, the data (biomarkers) captured by the plurality of biosensors 108a-b and the environmental data collected by the plurality of biosensors 108a-b. The database 214 of the application server 112 stores archived data of the users 102-104, threshold values and the like. For example, when the user X uses the application 110a-b at time t₁, the application 110a-b records values x, y and z for some pre-defined threshold parameters a, b and c. Thus, when the user X uses the application 110a-b again at time t₂, the application 110a-b considers the values recorded at time t₁ as archived data and compares the new values with the archived data values.

Moreover, the application 110a-b may record the threshold values (a set of pre-defined values) for the threshold parameters. For example, the application 110a-b may set value of the threshold parameters a, b and c as a₁, b₁ and c₁. The analysis module 210 analyzes the received plurality of the pre-defined set of one or more biomarkers associated with each of the one or more users 102-104 and the fetched plurality of the pre-defined set of one or more user-inputs from each of the one or more users 102-104 with respect to a plurality of pre-defined set of the one or more environmental parameters. Moreover, the analysis module 210 analyses the pre-defined set of one or more user-inputs received from each of the one or more users 102-104 and the set of one or more biomarkers received from the plurality of biosensors 108a-b to propose appropriate counter-measures for improving performance of athletes (the users 102-104). Further, the analysis module 210 compares the data (set of one or more biomarkers) of the users 102-104 to the threshold values stored in the database 214 of the application server 112. Examples of the set of one or more biomarkers include but may not be limited to heart beat, pulse rate, oxygen supply rate, muscle activation, posture, stress, blood pressure, galvanic skin response, gait and the like. If the received data does not satisfy the threshold values, then each of the applications 110a-b running in the communication devices 106a-106b issues reminders to each of the users 102-104. The reminders may include alarms, notifications, warnings and the like. For example, the applications 110a-b may notify the users 102-104 to hydrate themselves when the application server 112 determines dehydration of the users 102-104 due to various factors including improper hydration, stress, over work-out and the like. The reminders indicate imbalance in various factors including heart rate, respiration rate, oxygen saturation, temperature, stress, galvanic skin response and the like. The reminders issued by the application 110a-b may be used by the users 102-104 (for example, athletes) or a person in association with the users 102-104 (for example, a coach) to take appropriate measures to counter-balance the above stated issues. The application 110a-b may recommend certain exercises/activities to the users 102-104 to achieve appropriate threshold levels, thus improving performance of the users 102-104. In addition, the application 110a-b monitors location of the users 102-104 via Global Positioning System (GPS) and altitude via an altimeter.

The report generation module 212 of the application server 112 generates a profile for each of the one or more users 102-104 based on analysis of the received plurality of the pre-defined set of the one or more biomarkers and fetched plurality of the pre-defined set of the one or more user inputs with respect to the plurality of pre-defined set of the one or more environmental parameters. Moreover, the report generation module 212 generates a health report in form of a series of tables, waveforms, charts and the like to describe various factors related to the health issues of the users 102-104 at pre-defined time intervals. For example, the report generation module 212 may generate the health reports before an athletic event, during the athletic event, after the athletic event, and so forth.

In an embodiment of the present disclosure, the system 200 includes a determination module to determine optimal performance of each of the one or more users 102-104 based on the generated profile.

In another embodiment of the present disclosure, the system 200 includes a sharing module to share one or more pre-formatted messages with one or more stakeholders based on comparison of the generated profile and real time performance of each of the one or more users 102-104 during an event/match.

In yet another embodiment of the present disclosure, the input/output module 208 further enables transmission of one more recommendation messages by one or more stake holders based on determined optimal performance and comparison of the generated profile and real time performance of each of the one or more users 102-104 during the event.

In yet another embodiment of the present disclosure, the plurality of the pre-defined set of one or more biomarkers associated with each of the one or more users 102-104 are dynamically received through an associated communication device of each of the one or more users 102-104 at pre-defined time interval.

In yet another embodiment of the present disclosure, the plurality of a pre-defined set of the one or more user 102-104 inputs from each of the one or more users 102-104 are dynamically fetched through the associated communication device of each of one or more users 102-104 at pre-defined time interval.

In yet another embodiment of the present disclosure, the system 200 includes recommending each of the one or more users 102-104 pertaining to the pre-defined set of the one or more biomarkers.

In yet another embodiment of the present disclosure, the system 200 includes recommending each of the one or more users 102-104 for delivering an optimal performance during the event.

In yet another embodiment of the present disclosure, the application server 112 may generate the profile for each of the one or more users 102-104 based on physical and mental aspects of each of the one or more users 102-104, training schedules, environmental aspects and the like. The profiles for each of the one or more users 102-104 indicate trends that can be used to decide counter-measures and routines for the users 102-104 (athletes).

In yet another embodiment of the present disclosure, the application 110a-b analyses the physical and mental aspects of each of the one or more users 102-104 at the event/match by utilizing one or more user inputs and activities undertaken by the users 102-104 prior to the event. The application server 112 analyzes the performance of the users 102-104 during the event/match by analyzing various factors including physical and mental aspects of the users 102-104, the activities undertaken by the users 102-104 and the like. Further, the application server 112 determines optimal physical and mental aspects (thresholds) by comparing the various parameters related to the users 102-104. Furthermore, the application server 112 determines optimal training routines that should be followed by the users 102-104 to improve the performance of the users 102-104. The training routines may depend on the warnings/notifications issued by the application server 112. Furthermore, the application server 112 may enable a person, other than the users 102-104, to utilize the warnings/notifications for generating optimal training schedules for at least one of the one or more users 102-104. Thus, the application server 112 enables the users 102-104 to remain in a peak performance zone (high performance zone according to records from previous matches) for a longer period.

In an example, the application server 112 provides useful analysis and data to an athlete to encourage improvement in conditioning, training and preparation before a event. Moreover, as slight advantages can prove to be the critical difference in results and performance, the application server attempts to maximize the advantages that an athlete can obtain through training and pre-game preparation. Moreover, the athlete is required to wear the plurality of biosensors 108a-b in form of a biosensor band or a smart-watch, accelerometers inside his/her shoes and the like. The plurality of biosensors 108a-b are linked to an application that gathers data related to the athlete's heart rate, body temperature, respiration, blood flow, oxygen saturation, galvanic skin response, hydration, level of exercise intensity and the like through the plurality of biosensors 108a-b. In addition, the plurality of biosensors 108a-b collect data related to environmental aspects including temperature, weather, humidity, UV exposure and the like. The application server 112 enables the applications 110a-b to provide reminders/notifications/warnings to the athlete for various issues including dehydration, too long and severe workout, and the like. The application server 112 provides the reminders/notifications/warnings by analyzing water loss, heart rate, respiration, heart rate variability, mental stress, oxygen saturation, temperature, galvanic skin response, total exertion and the like. The application server 112 also monitors location and altitude of the athlete via a GPS (Global Positioning System) and an altimeter. Following the gathering of the different types of data via different types of sensors, the application server 112 provides an application or a spreadsheet type forms to enable the athlete to enter data relating to mental perception regarding exercises performed by him/her and diet of the athlete over a pre-defined period of time. Following gathering and collection of all types of required data, the application server 112 stores the data in the database 206. Further, the application server 112 enables customization/updating of the data when the athlete enters the game/match. The application server 112 prevents overexertion of the athlete by analyzing his or her mental state through the gathered data. In addition, the application server 112 compares the mental state with normal values (thresholds). If the mental state of the athlete is determined not to satisfy the normal values, the application server 112 enables the applications 110a-b to provide alerts. In addition, the application server 112 stores information about the athlete's heart rate, mental state and the like in practice/pre-game routine and contrasts them with in-game performances to find an optimal performance threshold for the user. Further, the application server 112 enables the creation of a profile of the athlete for optimal performance. Furthermore, the application server 112 enables generation of a series of tables and charts relating to specific aspects of the athlete's pre-game routine (gathered by the sensors-band and input in the spreadsheet), the sleep cycle and the mental state of the athlete in and prior to the event. Furthermore, the application server 112 may provide recommendations to the athlete for optimal performance in the form of activities that may be useful to the athlete using the results of analysis. The recommendation would be determined by the application server 112 by linking and comparing the performance of the athlete in an event with aspects of his or her pre-game routines, training regimen, mental state, and other quantifiable data aforementioned and analyzing the manner in which they appear to relate to match performance. Thus, the application server 112 enables the athlete to maximize his/her performance.

In yet another embodiment of the present disclosure, the application 110a-b may track signs of overexertion in the athletes (the users 102-104) due to workouts, over-practices and the like, by monitoring heart rate variability, blood pressure and the like and may provide notifications to the users 102-104.

In yet another embodiment of the present disclosure, the application 110a-b may track sleep cycle of the athletes (the users 102-104), including times of sleep, depth of sleep, mental status before sleeping, positions of sleep and the like; compare the sleep cycles of various athletes (the users 102-104) with one another and with match performance of the athletes (the users 102-104) and determine the best sleep cycle for each of the athletes (the users 102-104).

In yet another embodiment of the present disclosure, another person in association of the athletes (the users 102-104) (for example, a coach) may utilize the data of the report generation module 212 to regulate training regimes and select the most effective training method for boosting endurance of the athletes (the users 102-104), thus positively impacting the performance of the athletes (the users 102-104) in the athletic event/match.

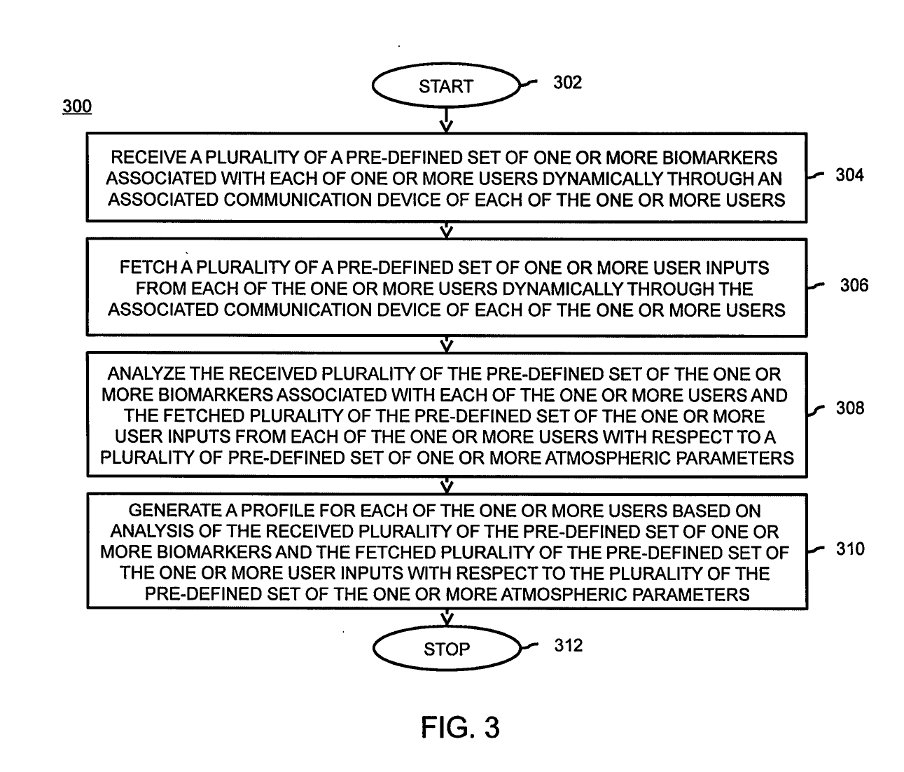

FIG. 3 is a flowchart 300 illustrating a method for controlling the performance of the athlete, in accordance with the various embodiments of the present disclosure. The flowchart initiates at step 302. Following the step 302, at a step 304, the application server 112 receives the plurality of the pre-defined set of the one or more biomarkers associated with each of the one or more users 102-104 dynamically through the associated communication device 106a-b of each of the one or more users 102-104. Following the step 304, at a step 306, the application server 112 fetches the plurality of the pre-defined set of the one or more user-inputs from each of the one or more users 102-104 dynamically through the associated communication device 106a-b of each of the one or more users 102-104. Following the step 306, at a step 308, the application server 112 analyzes the received plurality of the pre-defined set of the one or more biomarkers associated with each of the one or more users 102-104 and the fetched plurality of the pre-defined set of the one or more user-inputs from each of the one or more users 102-104 with respect to the plurality of pre-defined set of the one or more environmental parameters. Following the step 308, at a step 310, the application server 112 generates a profile for each of the one or more users 102-104 based on analysis of the received plurality of the pre-defined set of one or more biomarkers and the fetched plurality of the pre-defined set of one or more user-inputs with respect to the plurality of the pre-defined set of the one or more environmental parameters. The flowchart terminates at a step 312.

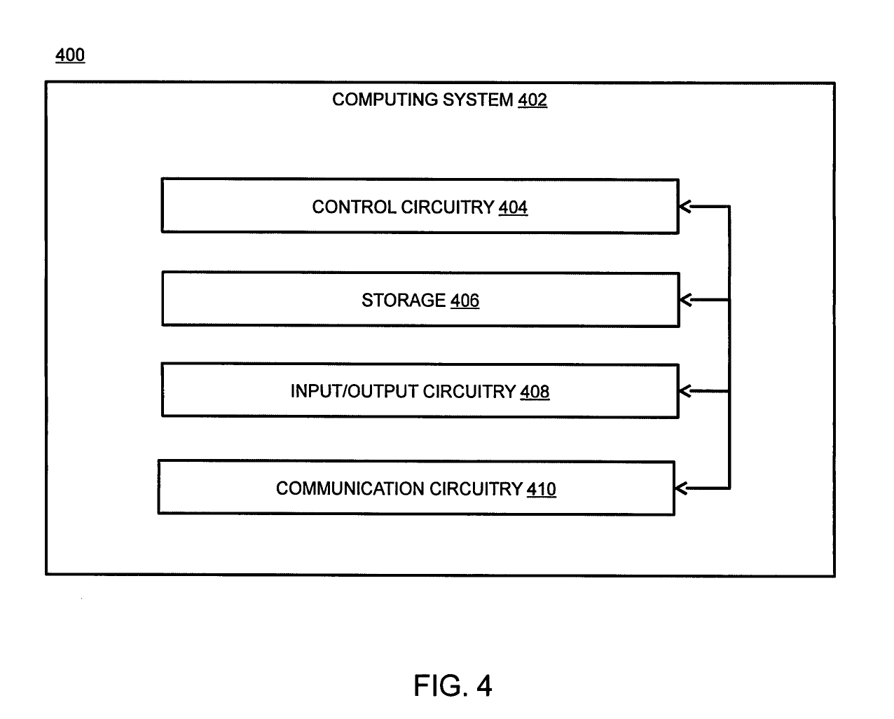

FIG. 4 illustrates a block diagram 400 of a dedicated computer 402 that acts as the server 106, in accordance with various embodiments of the present disclosure. It may be noted that to explain the block diagram 400 of the dedicated computer 402 that acts as the application server 112, references will be made to the various elements of the system 100.

The dedicated computer 402 includes but may not be limited to a control circuitry 404, storage 406, an input/output circuitry 408, and a communication circuitry 410.

From the perspective of this disclosure, the control circuitry 404 includes any processing circuitry or processor operative to control the operations and performance of the dedicated computer 402. For example, the control circuitry 404 may be used to run operating system applications, firmware applications, media playback applications, media editing applications, or any other application. In an embodiment, the control circuitry 404 drives a display and process inputs received from a user interface.

From the perspective of this disclosure, the storage 406 includes one or more storage mediums including a hard-drive, solid state drive, flash memory, permanent memory such as ROM, any other suitable type of storage component, or any combination thereof. The Storage 406 may store, for example, media data (e.g., music and video files), application data (e.g., for implementing functions on the dedicated computer 402).

From the perspective of this disclosure, the I/O circuitry 408 may be operative to convert (and encode/decode, if necessary) analog signals and other signals into digital data. In an embodiment, the I/O circuitry 408 may also convert digital data into any other type of signal, and vice-versa. For example, the I/O circuitry 408 may receive and convert physical contact inputs (e.g., from a multi-touch screen), physical movements (e.g., from a mouse or sensor), analog audio signals (e.g., from a microphone), or any other input. The digital data may be provided to and received from the control circuitry 404, the storage 406, or any other component of the dedicated computer 402.

It may be noted that the I/O circuitry 408 is illustrated in FIG. 3 as a single component of the dedicated computer 402; however those skilled in the art would appreciate that several instances of the I/O circuitry 408 may be included in the dedicated computer 402.

The dedicated computer 402 may include any suitable interface or component for allowing a user to provide inputs to the I/O circuitry 408. The dedicated computer 402 may include any suitable input mechanism. Examples of the input mechanism include but may not be limited to a button, keypad, dial, a click wheel, and a touch screen. In an embodiment of the present disclosure, the dedicated computer 402 may include a capacitive sensing mechanism, or a multi-touch capacitive sensing mechanism.

In an embodiment, the dedicated computer 402 may include specialized output circuitry associated with output devices such as, for example, one or more audio outputs. The audio output may include one or more speakers built into the dedicated computer 402, or an audio component that may be remotely coupled to the dedicated computer 402.

The one or more speakers can be mono speakers, stereo speakers, or a combination of both. The audio component can be a headset, headphones or ear buds that may be coupled to communications device with a wire or wirelessly.

In an embodiment, the I/O circuitry 408 may include display circuitry for providing a display visible to the user. For example, the display circuitry may include a screen (e.g., an LCD screen) that is incorporated in the dedicated computer 402.

The display circuitry may include a movable display or a projecting system for providing a display of content on a surface remote from the dedicated computer 402 (e.g., a video projector). In an embodiment, the display circuitry may include a coder/decoder to convert digital media data into analog signals. For example, the display circuitry may include video Codecs, audio Codecs, or any other suitable type of Codec.

The display circuitry may include display driver circuitry, circuitry for driving display drivers, or both. The display circuitry may be operative to display content. The display content can include media playback information, application screens for applications implemented on the electronic device, information regarding ongoing communications operations, information regarding incoming communications requests, or device operation screens under the direction of the control circuitry 404. Alternatively, the display circuitry may be operative to provide instructions to a remote display.

From the prospective of this disclosure, the communications circuitry 410 may include any suitable communications circuitry operative to connect to a communications network and to transmit communications (e.g., voice or data) from the dedicated computer 402 to other devices within the communications network. The communications circuitry 410 may be operative to interface with the communications network using any suitable communications protocol. Examples of the communications protocol include but may not be limited to Wi-Fi, Bluetooth® radio frequency systems, infrared, LTE, GSM, GSM plus EDGE, CDMA, and quadband.

In an embodiment of the present disclosure, the same instance of the communications circuitry 410 may be operative to provide for communications over several communications networks. In an embodiment of the present disclosure, the dedicated computer 402 may be coupled a host device for data transfers, synching the communications device, software or firmware updates, providing performance information to a remote source (e.g., providing riding characteristics to a remote server) or performing any other suitable operation that may require the dedicated computer 402 to be coupled to a host device. Several computing devices may be coupled to a single host device using the host device as a server. Alternatively or additionally, the dedicated computer 402 may be coupled to several host devices (e.g., for each of the plurality of the host devices to serve as a backup for data stored in the dedicated computer 402).

In an aspect of the present disclosure, minute details and factors affecting performance of the athletes can be monitored. For example, performance of the athlete may get deteriorated due to factors including stress increment, high blood pressure, heart problems and the like. The method and system provided in the present invention enables the athlete or any person in association of the athlete to monitor the factors at regular time intervals and adopt appropriate measures to counter-balance the various parameters affecting performance of the athlete. Moreover, the method and system enables the athletes to analyze their performance at various instances of the athletic event including practice session, live event, after event and the like. Further, the method and system enables the athletes to improve their performance in real time. Furthermore, the method and system enables the athletes to determine the level of performance. Furthermore, the method and system analyzes correlation between various exercise routines, health issues, and match performance to provide analysis report for the athletes. Furthermore, the method and system notifies the athletes in real time when their performance is not optimal.

While the disclosure has been presented with respect to certain specific embodiments, it will be appreciated that many modifications and changes may be made by those skilled in the art without departing from the spirit and scope of the disclosure. It is intended, therefore, by the appended claims to cover all such modifications and changes as fall within the true spirit and scope of the disclosure.

What is claimed is:

1. A method comprising:
receiving a plurality of a pre-defined set of one or more biomarkers associated with each of one or more users dynamically through an associated communication device of each of the one or more users;
fetching a plurality of a pre-defined set of one or more user inputs from each of the one or more users dynamically through the associated communication device of each of the one or more users;
analyzing the received plurality of the pre-defined set of one or more biomarkers associated with each of the one or more users and the fetched plurality of the pre-defined set of the one or more user inputs from each of the one or more users with respect to a plurality of pre-defined set of one or more environmental parameters; and
generating a profile for each of the one or more users based on analysis of the received plurality of the pre-defined set of the one or more biomarkers and the fetched plurality of the pre-defined set of the one or more user inputs with respect to the plurality of the pre-defined set of the one or more environmental parameters.

2. The method as recited in claim 1, further comprising determining an optimal performance of each of the one or more users based on the generated profile.

3. The method as recited in claim 2, further comprising sharing one or more pre-formatted messages with one or more stakeholders based on comparison of the generated profile and a real time performance of each of the one or more users during an event.

4. The method as recited in claim 3, further comprising enabling transmission of one more recommendation messages by the one or more stakeholders based on a determined optimal performance and the comparison of the generated profile and the real time performance of each of the one or more users during the event.

5. The method as recited in claim 1, wherein the plurality of the pre-defined set of the one or more biomarkers associated with each of the one or more users are dynamically received through the associated communication device of each of the one or more users at a pre-defined time interval.

6. The method as recited in claim 1, wherein the plurality of the pre-defined set of the one or more user inputs from each of the one or more users are dynamically fetched through the associated communication device of each of the one or more users at a pre-defined time interval.

7. The method as recited in claim 1, further comprising recommending each of the one or more users pertaining to the pre-defined set of the one or more biomarkers.

8. The method as recited in claim 1, further comprising recommending each of the one or more users pertaining to the optimal performance.

9. The method as recited in claim 2, further comprising recommending each of the one or more users for delivering the optimal performance during an event.

10. A system comprising:
an input/output module configured to:
receiving a plurality of a pre-defined set of one or more biomarkers associated with each of one or more users dynamically through an associated communication device of each of the one or more users;
fetching a plurality of a pre-defined set of one or more user inputs from each of the one or more users dynamically through the associated communication device of each of the one or more users;
an analysis module configured to analyze the received plurality of the pre-defined set of the one or more biomarkers associated with each of the one or more users and the fetched plurality of the pre-defined set of the one or more user inputs from each of the one or more users with respect to a plurality of pre-defined set of one or more environmental parameters; and
a report generation module configured to generate a profile for each of the one or more users based on analysis of the received plurality of the pre-defined set of the one or more biomarkers and the fetched plurality of the pre-defined set of the one or more user inputs with respect to the plurality of the pre-defined set of the one or more environmental parameters.

11. The system as recited in claim 10, further comprising a determination module configured to determine an optimal performance of each of the one or more users based on the generated profile.

12. The system as recited in claim 11, further comprising a sharing module configured to share one or more pre-formatted messages with one or more stakeholders based on comparison of the generated profile and a real time performance of each of the one or more users during an event.

13. The system as recited in claim 11, wherein the input/output module further configured to enable transmission of one more recommendation messages by one or more stake holders based on the determined optimal performance and the comparison of the generated profile and the real time performance of each of the one or more users during the event.

14. The system as recited in claim 11, wherein the plurality of the pre-defined set of the one or more biomarkers associated with each of the one or more users are dynamically received through the associated communication device of each of the one or more users at a pre-defined time interval.

15. The system as recited in claim 11, wherein the plurality of the pre-defined set of the one or more user inputs from each of the one or more users are dynamically fetched through the associated communication device of each of the one or more users at a pre-defined time interval.

16. The system as recited in claim 11, further comprising recommending each of the one or more users pertaining to the pre-defined set of the one or more biomarkers.

17. The system as recited in claim 11, further comprising recommending each of the one or more users pertaining to the optimal performance.

18. The system as recited in claim 11, further comprising recommending each of the one or more users for delivering the optimal performance during the event.

19. A computer system comprising:
one or more processors; and
a non-transitory memory containing instructions that, when executed by said one or more processors, causes said one or more processors to perform a set of steps comprising:
receiving, by an input/output module, a plurality of a pre-defined set of one or more biomarkers associated with each of one or more users dynamically through an associated communication device of each of the one or more users;
fetching, by an input/output module, a plurality of a pre-defined set of one or more user inputs from each of the one or more users dynamically through the associated communication device of each of the one or more users;
analyzing, by an analysis module, the received plurality of the pre-defined set of the one or more biomarkers associated with each of the one or more users and the fetched plurality of the pre-defined set of the one or more user inputs from each of the one or more users with respect to a plurality of pre-defined set of one or more environmental parameters; and
generating, by a report generation module, a profile for each of the one or more users based on analysis of the received plurality of the pre-defined set of the one or more biomarkers and the fetched plurality of the pre-defined set of the one or more user inputs with respect to the plurality of the pre-defined set of the one or more environmental parameters.

20. The computer system as recited in claim 19, wherein said non-transitory memory containing instructions that, when executed by said one or more processors, cause said one or more processors to perform a further step of determining an optimal performance of each of the one or more users based on the generated profile.
